(19) United States
(12) Patent Application Publication
(10) Pub. No.: US 2014/0161995 A1
(43) Pub. Date: Jun. 12, 2014

(54) ACRYLIC ADHESIVE COMPOSITION, POLARIZING PLATE, AND LIQUID CRYSTAL DISPLAY INCLUDING THE SAME

(71) Applicant: CHEIL INDUSTRIES INC., Gumi-si (KR)

(72) Inventors: Ik Hwan CHO, Uiwang-si (KR); In cheon HAN, Uiwang-si (KR)

(73) Assignee: CHEIL INDUSTRIES INC., Gumi-si (KR)

(21) Appl. No.: 14/097,030

(22) Filed: Dec. 4, 2013

(30) Foreign Application Priority Data
Dec. 11, 2012 (KR) 10-2012-0143945

(51) Int. Cl. G02B 1/04; C09J 7/02

(52) U.S. Cl. CPC G02B 1/04; C09J 7/0239
USPC 428/1.53; 522/170; 522/31; 522/109; 525/118; 428/413

(57) ABSTRACT

An acrylic adhesive composition includes: an acrylic resin; an epoxy resin; and a cationic photoinitiator, the acrylic adhesive composition having a storage modulus of about 6×10⁶ dyne/cm² to about 1×10⁸ dyne/cm² at 25° C. and a storage modulus of about 5×10³ dyne/cm² to about 1×10⁶ dyne/cm² at 80° C. A polarizing plate includes a polarizing film and an adhesive layer on one or both sides of the polarizing film, the adhesive layer including a cured product of the acrylic adhesive composition. A liquid crystal display including a liquid crystal panel and the polarizing plate on one or both sides of the liquid crystal panel is also disclosed.

### CROSS-REFERENCE TO RELATED APPLICATION

This application claims priority to and the benefit of Korean Patent Application No. 10-2012-0143945, filed on Dec. 11, 2012, in the Korean Intellectual Property Office, the entire content of which is incorporated herein by reference.

### TECHNICAL FIELD

Aspects of embodiments according to the present invention relate to an acrylic adhesive composition, a polarizing plate and a liquid crystal display including a cured product of the acrylic adhesive composition. For example, aspects of embodiments according to the present invention relate to an acrylic adhesive composition that enables optical compensation for negative birefringence between an adhesive (e.g., an adhesive layer) and a triacetyl cellulose protective film, and that enables inhibition (or reduction) of light leakage due to changes in the size of the polarizing plate. Additional aspects of embodiments according to the present invention relate to a polarizing plate including an adhesive layer including the cured product of the acrylic adhesive composition, and a liquid crystal display including the polarizing plate.

### DESCRIPTION OF THE RELATED ART

A liquid crystal display is an apparatus including liquid crystals between two thin glass substrates, and is capable of displaying images. When a voltage is applied to the liquid crystal display through electrodes connected to the liquid crystals, the molecular arrangement of the liquid crystals changes, thus changing the transmittance of light through a layer including the liquid crystals, and thereby enabling the display of pictures and/or colors. Liquid crystal displays are used in various fields because they possess various advantages, such as low electrical consumption, thin and flat structures, and the like.

In general, a liquid crystal display includes liquid crystal cells including liquid crystals between substrates on which transparent electrodes are formed. The liquid crystal display also includes a polarizing plate, and a bonding layer (or an adhesive layer) for bonding the polarizing plate to one of the substrates.

The polarizing plate may include iodine compounds or dichroic polarizing materials arranged in a predetermined (or set) direction, and may have a multilayered structure in which a polarizing film or a triacetyl cellulose protective film is on (or stacked on) both sides of the polarizing plate. In an effort to improve performance of the polarizing plate, additional films, such as a retardation film, a wide viewing angle compensation plate, a brightness enhancing film, and the like, may additionally be on the polarizing plate.

As can be seen from the above description, the respective films of the multilayered polarizing plate are made of materials having molecular structures and compositions that are different from one another, and, thus, exhibit different physical properties. For example, under high temperature and/or high humidity conditions, the polarizing plate including materials having unidirectional molecular arrangements may lack dimensional stability due to those materials exhibiting shrinkage or expansion behavior that is different from those of the other films of the polarizing plate. If the polarizing plate is secured (or attached) via an adhesive (e.g., an adhesive layer), stress may be concentrated on the triacetyl cellulose layer (e.g., a protective film) under high temperature and/or high humidity conditions, thereby causing birefringence and light leakage.

In an effort to resolve such problems, methods of relieving stress on the adhesive have been attempted. For example, methods for designing an adhesive to exhibit large creeping against external strain and, which can be adapted to polarizing plates, have been attempted. However, these methods have disadvantages in that the cutting properties or workability of the adhesive are significantly deteriorated. When the cutting properties or workability of the adhesive are deteriorated, the adhesive can exhibit defects such as exudation or press-down of the adhesive during mass production of polarizing plates, thereby reducing yield.

On the other hand, there have been attempts to minimize light leakage through very hard adhesives. For example, adhesives can be prepared by a method of adding a polyfunctional acrylate, an isocyanate curing agent and a photoinitiator to a carboxyl group-containing acrylic copolymer to prepare an adhesive, followed by curing via ultraviolet irradiation. Adhesives can also be prepared by a method of mixing a hydroxyl group-containing copolymer and a carboxyl group-containing copolymer in a predetermined (or set) ratio, adding a polyfunctional acrylate, a polyfunctional isocyanate curing agent and a photoinitiator to prepare an adhesive composition, and curing the adhesive composition via ultraviolet irradiation to prepare an adhesive. However, the foregoing adhesives may have significantly lower initial adhesion depending on the storage modulus (G′), thereby causing severe light leakage or poor durability under high temperatures and/or high humidity.

### SUMMARY

Aspects of embodiments according to the present invention are directed to an acrylic adhesive composition that enables optical compensation for negative birefringence between (or exhibited by) an adhesive layer (including a cured product of the acrylic adhesive composition) and a polarizing plate protective film. Embodiments of the cured product exhibit low storage modulus at high temperature, and inhibit light leakage due to changes in the size of a polarizing plate including the adhesive layer. Embodiments of the adhesive layer are capable of controlling phase separation upon curing. Embodiments of the present invention relate to a polarizing plate including the adhesive layer, and to a liquid crystal display including the adhesive layer.

One aspect of an embodiment according to the present invention relates to an acrylic adhesive composition. An embodiment of the acrylic adhesive composition includes: an acrylic resin; an epoxy resin; and a cationic photoinitiator. A cured product of the acrylic adhesive composition has a storage modulus of about 6×10⁶ dyne/cm² to about 1×10⁸ dyne/cm² at 25° C., and a storage modulus of about 5×10³ dyne/cm² to about 1×10⁵ dyne/cm² at 80° C.

In one embodiment, the acrylic resin may be a copolymer of a monomer mixture including about 75% by weight (wt %) to about 99.5 wt % of a C₄ to C₂₀ alkyl (meth)acrylate, and about 0.5 wt % to about 25 wt % of a hydroxyl group-containing monomer, based on the total weight of the acrylic resin.

In one embodiment, the acrylic resin may have a weight average molecular weight of about 700,000 g/mol or more.

In one embodiment, the acrylic resin may have a glass transition temperature of about −40° C. to about −5° C.

In one embodiment, the epoxy resin may be an epoxy compound having two or more epoxy functional groups.

In one embodiment, the epoxy resin may include at least one of bisphenol A epoxy, bisphenol F epoxy, brominated bisphenol epoxy, 1,4-cyclohexanedimethanol diglycidyl ether, novolac epoxy, 1,6-hexanediol diglycidyl ether, and/or trimethylol propane triglycidyl ether.

In one embodiment, the cationic photoinitiator may include at least one of iron-arene complexes and onium salts including at least one of an aromatic diazonium salt, an aromatic iodonium salt and/or an aromatic sulfonium salt.

In one embodiment, the epoxy resin may be present in the acrylic adhesive composition in an amount of about 30 parts by weight to about 95 parts by weight, and the cationic photoinitiator may be present in the acrylic adhesive composition in an amount of about 0.5 parts by weight to about 3 parts by weight, based on 100 parts by weight of the acrylic resin.

In one embodiment, the acrylic adhesive composition may further include a silane coupling agent.

In one embodiment, an adhesive layer includes a cured product of the acrylic adhesive composition and the cured product has a degree of cross-linking of about 50% to about 98% after curing with ultraviolet light.

Another aspect of an embodiment according to the present invention relates to a polarizing plate. An embodiment of the polarizing plate includes a polarizing film; and an adhesive layer on one or both sides of the polarizing film, where the adhesive layer includes a cured product of the acrylic adhesive composition.

A further aspect of an embodiment according to the present invention relates to a liquid crystal display. An embodiment of the liquid crystal display includes a liquid crystal panel, and the polarizing plate is on one or both sides of the liquid crystal panel.

### DETAILED DESCRIPTION

In the following detailed description, only certain embodiments of the present invention are shown and described, by way of illustration. As those skilled in the art would recognize, the invention may be embodied in many different forms and should not be construed as limited to the embodiments set forth herein. Also, in the context of the present application, when a first element is referred to as being “on” a second element, it can be directly on the second element or be indirectly on the second element with one or more intervening elements therebetween. Expressions such as “at least one of,” when preceding a list of elements, modify the entire list of elements and do not modify the individual elements of the list. Further, the use of “may” when describing embodiments of the present invention refers to “one or more embodiments of the present invention.”

Embodiments of the present invention will now be described. The acrylic adhesive composition according to one embodiment of the invention includes (A) an acrylic resin, (B) an epoxy resin, and (C) a cationic photoinitiator.

According to embodiments of the present invention, the acrylic resin may be a hydroxyl group-containing acrylic copolymer.

In one embodiment, the acrylic resin may be a copolymer of a monomer mixture including a C₄ to C₂₀ alkyl (meth)acrylate and a hydroxyl group-containing monomer.

As used herein, the term “(meth)acrylate” encompasses both acrylates and methacrylates.

Examples of the C4 to C20 alkyl (meth)acrylate may include butyl (meth)acrylate, pentyl (meth)acrylate, hexyl (meth)acrylate, heptyl (meth)acrylate, octyl (meth)acrylate, nonyl (meth)acrylate, decyl (meth)acrylate, dodecyl (meth)acrylate, and lauryl (meth)acrylate, but the C4 to C20 alkyl (meth)acrylate is not limited thereto. A single C4 to C20 alkyl (meth)acrylate may be used or a combination of C4 to C20 alkyl (meth)acrylates may be used. The C₄ to C₂₀ alkyl (meth)acrylate may be present in the acrylic adhesive composition in an amount of about 75 wt % to about 99.5 wt %, for example, about 85 wt % to about 98 wt %, based on the total amount of the acrylic resin. Within any of these ranges, an adhesive layer including a cured product of the acrylic adhesive composition can exhibit good adhesion, durability, and the like.

Examples of the hydroxyl group-containing monomer may include 2-hydroxyethyl (meth)acrylate, 4-hydroxybutyl (meth)acrylate, 2-hydroxypropyl (meth)acrylate, 2-hydroxybutyl (meth)acrylate, 6-hydroxyhexyl (meth)acrylate, 1,4-cyclohexanedimethanol mono(meth)acrylate, chloro-2-hydroxypropyl acrylate, diethylene glycol mono (meth)acrylate, and allyl alcohol, but the hydroxyl group-containing monomer is not limited thereto. A single hydroxyl group-containing monomer may be used or a combination of hydroxyl group-containing monomers may be used. The hydroxyl group-containing monomer is present in the acrylic adhesive composition in an amount of about 0.5 wt % to about 25 wt %, for example, about 2 wt % to about 15 wt %, based on the total amount of the acrylic resin. Within any of these ranges, an adhesive layer including a cured product of the acrylic adhesive composition can exhibit good durability and reliability, adhesion, peel strength, and the like.

The acrylic resin may be polymerized with other copolymerizable monomers together with any of the aforementioned monomers. For example, the acrylic resin may be polymerized with a monomer having positive birefringence, such as an aromatic (meth)acrylate, as desired.

According to embodiments of the present invention, any suitable method for preparing an acrylic resin may be used (without limitation) to prepare the acrylic resin. For example, the acrylic resin may be prepared by general polymerization, such as solution polymerization, photo polymerization, bulk polymerization, suspension polymerization, emulsion polymerization, or the like. For example, the acrylic resin may be prepared via solution polymerization. Solution polymerization may be performed by adding an initiator to a monomer mixture obtained by uniformly mixing the monomers of the mixture and polymerizing the monomer mixture at a polymerization temperature of about 50° C. to about 140° C. Examples of the initiator may include azo initiators, such as azobisisobutyronitrile, azobiscyclohexane carbonitirile, and the like, and initiators including peroxides, such as benzoyl peroxide, acetyl peroxide and the like, but the initiator is not limited thereto. A single initiator may be used or a combination of initiators may be used.

The acrylic resin may have a weight average molecular weight of about 700,000 g/mol or more, for example, about 800,000 g/mol to about 2,000,000 g/mol. Within any of these ranges, an adhesive layer including a cured product of the adhesive composition can exhibit good durability.

The acrylic resin may have a glass transition temperature of about −40° C. to about −5° C., for example, about −35° C. to about −15° C., or about −35° C. to about −25° C. Within any of these ranges, an adhesive layer including a cured product of the acrylic adhesive composition can exhibit good initial adhesion.

The epoxy resin according to embodiments of the present invention may be a cationic reactive epoxy resin having positive birefringence.

In one embodiment, the epoxy resin may be an epoxy compound having two or more epoxy functional groups. Examples of the epoxy resin may include bisphenol A epoxy, bisphenol F epoxy, brominated bisphenol epoxy, 1,4-cyclohexanedimethanol diglycidyl ether, novolac epoxy, 1,6-hexanediol diglycidyl ether, trimethylol propane triglycidyl ether, and mixtures thereof, but the epoxy resin is not limited thereto.

The epoxy resin may be present in the acrylic adhesive composition in an amount of about 30 parts by weight to about 95 parts by weight, for example, about 50 parts by weight to about 90 parts by weight, or about 70 parts by weight to about 88 parts by weight, based on 100 parts by weight of the acrylic resin. Within any of these ranges, an adhesive layer including a cured product of the acrylic adhesive composition can optically compensate for negative birefringence between the adhesive layer and a polarizing plate protective film (for example, a TAC (triacetyl cellulose) protective film) upon shrinkage of the polarizing plate. Additionally, within any of those ranges, the cured product of the acrylic adhesive composition can have a high storage modulus at room temperature and a low storage modulus at high temperatures, and can exhibit good durability.

The cationic photoinitiator used in embodiments of the present invention may be a compound capable of generating cation species or Lewis acids upon being irradiated by activation energy beams.

Examples of the cationic photoinitiator may include onium salts, such as aromatic diazonium salts, aromatic iodonium salts, aromatic sulfonium salts and the like, iron-arene complexes, and mixtures thereof, but the cationic photoinitiator is not limited thereto. In addition, a photosensitizer may be used depending on the efficiency of the initiator (e.g., the cationic photoinitiator).

The cationic photoinitiator may be present in the acrylic adhesive composition in an amount of about 0.5 parts by weight to about 3 parts by weight, for example, about 0.7 parts by weight to about 1.8 parts by weight, based on 100 parts by weight of the acrylic resin. Within any of these ranges, upon curing the acrylic adhesive composition, phase separation of the acrylic adhesive composition can be controlled and the degree of curing can be high, thereby providing high durability.

The acrylic adhesive composition may further include a silane coupling agent.

The silane coupling agent may stabilize adhesion and attachment stability between an adhesive including a cured product of the acrylic adhesive composition and glass substrates, thereby improving heat resistance and moisture resistance of the resultant. When the adhesive is left under high temperature and/or high humidity conditions, the silane coupling agent may serve to enhance attachment reliability of the adhesive to one or more of the glass substrates.

Nonlimiting examples of the silane coupling agent may include γ-glycidoxypropyl triethoxysilane, γ-glycidoxypropyl trimethoxysilane, γ-glycidoxypropyl methyldiethoxysilane, γ-glycidoxypropyl triethoxysilane, 3-mercaptopropyl trimethoxy silane, vinyl trimethoxysilane, vinyl triethoxysilane, γ-methacryloxypropyl trimethoxysilane, γ-methacryloxypropyl triethoxysilane, γ-aminopropyl trimethoxysilane, γ-aminopropyl triethoxysilane, 3-isocyanatopropyl triethoxysilane, γ-acetoacetate propyl trimethoxysilane, γ-acetoacetate propyl triethoxysilane, β-cyanoacetyl trimethoxy silane, β-cyanoacetyl triethoxysilane, acetoxyaceto trimethoxy silane, and mixtures thereof. Although a silane coupling agent having an acetoacetate group or β-cyanoacetyl group may be used, the silane coupling agent is not limited thereto. When the acrylic adhesive composition includes the silane coupling agent, the silane coupling agent may be present in the acrylic adhesive composition in an amount of about 0.01 parts by weight to about 5 parts by weight, for example about 0.05 parts by weight to about 1 part by weight, based on 100 parts by weight of the acrylic resin. Within any of these ranges, a cured product of the acrylic adhesive composition can exhibit good durability and reliability, and improved adhesion.

The acrylic adhesive composition according to embodiments of the invention may further include additives, such as cure accelerating agents, ionic liquids, lithium salts, inorganic fillers, softening agents, antioxidants, anti-aging agents, stabilizers, tackifiers, leveling agents, antibubbling agents, plasticizers, dyes, pigments (e.g., coloring pigments, sieving pigments, and the like), treating agents, sunscreens, brightening agents, dispersing agents, heat stabilizers, light stabilizers, ultraviolet absorbers, antistatic agents, lubricants, solvents, and mixtures thereof, as desired.

The acrylic adhesive composition according to embodiments of the present invention may form a soft adhesive layer (e.g., an adhesive or adhesive film) upon curing at room temperature. For example, the acrylic adhesive composition may be coated onto a release film and subjected to heat drying, followed by UV curing to form an adhesive layer. In one embodiment, heat drying may be performed at about 80° C. or higher, for example, about 80° C. to about 150° C. UV curing after heat drying may be performed at an ultraviolet intensity of about 800 mW/cm² or greater, for example, about 800 mJ/cm² to about 2,000 mJ/cm². The adhesive layer may have a thickness of, for example, about 15 μm to about 40 μm, but the thickness is not limited thereto.

An embodiment of a cured product of the acrylic adhesive composition has a storage modulus at 25° C. of about 6×10⁶ dyne/cm² to about 1×10⁸ dyne/cm², for example, about 8×10⁶ dyne/cm² to about 8×10⁷ dyne/cm², and a storage modulus at 80° C. of about 5×10³ dyne/cm² to about 1×10⁵ dyne/cm², for example, about 7×10³ dyne/cm² to about 8×10⁴ dyne/cm².

The storage modulus may be measured by stacking adhesive layers (e.g., adhesives) obtained by UV curing/heat curing the acrylic adhesive composition to prepare a test specimen having a diameter of 8 mm and a thickness of 1 mm, followed by measuring the storage modulus using an ARES (Advanced Rheometry Expansion System) at 25° C. and 80° C. in accordance with Frequency Sweep Testing (frequency: 1 Hz basis).

When the storage modulus at 25° C. of a cured product of the acrylic adhesive composition is less than about 6×10⁶ dyne/cm², or the storage modulus at 80° C. is less than about 5×10³ dyne/cm², an adhesive including the cured product can be too soft, causing deterioration in reliability. When the storage modulus at 25° C. exceeds about 1×10⁸ dyne/cm², or the storage modulus at 80° C. exceeds about 1×10⁵ dyne/cm², the adhesive can exhibit low adhesion or can allow light leakage.

Further, the cured product may have a degree of crosslinking of about 50% to about 98%, for example, about 70% to about 90%. Within any of these ranges, an adhesive including the cured product can inhibit the occurrence of light leakage due to size changes in the polarizing plate.

The adhesive layer may have a peel strength of, for example, about 300 gf/25 mm to about 1,000 gf/25 mm, as measured in accordance with the method for evaluating physical properties as disclosed in the below-described Examples.

Another aspect of an embodiment according to the present invention relates to a polarizing plate. The polarizing plate according to an embodiment of the present invention includes a polarizing film; and an adhesive layer on (e.g., formed on) one or both sides of the polarizing film. The adhesive layer includes a cured product of the acrylic adhesive composition. Methods of preparing the polarizing plate and polarizing film will be instantly recognized by those of ordinary skill in the art.

A further aspect of an embodiment according to the present invention relates to a liquid crystal display. The liquid crystal display according to an embodiment of the present invention may include a liquid crystal panel and the polarizing plate attached to one or both sides of the liquid crystal panel. Methods of preparing the liquid crystal display will be instantly recognized by those of ordinary skill in the art.

Next, embodiments of the present invention will be described with reference to the following examples. It will be understood that these examples are provided for illustration only and are not to be in any way construed as limiting the present invention.

### EXAMPLES

### Example 1

An acrylic resin (weight average molecular weight: 900,000 g/mol; glass transition temperature: −35° C.) was prepared by polymerization of a monomer mixture including 95 parts by weight of butyl acrylate, 5 parts by weight of hydroxybutyl acrylate and a heat initiator (v70, Wako).

Then, an acrylic adhesive composition was prepared by mixing 100 parts by weight of the prepared acrylic resin, 70 parts by weight of bisphenol A epoxy as an epoxy resin, 1.5 parts by weight of a cationic photoinitiator (CPI 210S, supplied by San-Apro Co., Ltd., Kyoto, Japan), and 0.1 parts by weight of a silane coupling agent (KBM-403, supplied by Shin-Etsu Chemical Co., Ltd., Tokyo, Japan) in accordance with the composition listed in Table 1.

The prepared acrylic adhesive composition was applied to a 38 μm thick polyethylene terephthalate film (release PET), which was subjected to silicone release treatment such that the thickness of a resultant adhesive layer after drying would be 20 μm. Then, the adhesive layer was attached to a polarizing plate, cured by UV irradiation under conditions of 800 mW/cm² and 2000 mJ/cm² using a metal halide lamp (UV curing machine, Lichtzen), and maintained at room temperature for 3 days, thereby preparing a polarizing plate to which an adhesive layer was attached.

### Comparative Example 1

A polarizing plate was manufactured as in Example 1 except that 15 parts by weight of isocyanurate resin (M315, supplied by Donga Synthetics Co.) and 1.5 parts by weight of a radical initiator (Irgacure 184, supplied by BASF SE) were used instead of the bisphenol A epoxy and cationic photoinitiator.

### Comparative Example 2

A polarizing plate was manufactured as in Example 1 except that 0.4 parts by weight of isocyanate crosslinking agent (Lupranate, supplied by BASF SE) was used instead of the bisphenol A epoxy and the cationic photoinitiator, and UV irradiation was not performed.

### Comparative Example 3

A polarizing plate was manufactured as in Example 1 except that 70 parts by weight of an isocyanurate resin (M315, supplied by Donga Synthetics Co.) and 1.5 parts by weight of a radical initiator (Irgacure 184, supplied by BASF SE) were used instead of the bisphenol A epoxy and the cationic photoinitiator.

TABLE 1

| | | | Comparative | Comparative | Comparative |
|---|---|---|---|---|---|
| | | Example 1 | Example 1 | Example 2 | Example 3 |
| Acrylic resin | | 100 | 100 | 100 | 100 |
| Resin | Bisphenol A | 70 | — | — | — |
| | epoxy | | | | |
| | Isocyanurate | — | 15 | — | 70 |
| Isocyanate crosslinking | | — | — | 0.4 | — |
| agent | | | | | |
| Initiator | Cation | 1.5 | — | — | — |
| | Radical | — | 1.5 | — | 1.5 |

| | | | | |
|---|---|---|---|---|
| Silane coupling agent | 0.1 | 0.1 | 0.1 | 0.1 |
| Preparation method | UV/heat | UV/heat | Heat curing | UV/heat |
| | curing | curing | | curing |
| Peel strength | 400 | 400 | 600 | 50 |
| (gf/25 mm) | | | | |
| Durability | ◯ | ◯ | ◯ | X |
| Storage modulus (25° C.) | 3 * 10\hat{ }7 | 8 * 10\hat{ }6 | 4 * 10\hat{ }5 | 5 * 10\hat{ }7 |
| (dyne/cm²) | | | | |
| Storage modulus (80° C.) | 2 * 10\hat{ }4 | 7 * 10\hat{ }5 | 7 * 10\hat{ }3 | 1 * 10\hat{ }6 |
| (dyne/cm²) | | | | |
| Degree of crosslinking (%) | 88 | 90 | 55 | 97 |
| Inhibition of light leakage | ⊚ | ◯ | Δ | X (Reliability |
| | | | | NG) |

Unless otherwise indicated, the units shown in Table 1 are parts by weight.

### Methods for Evaluating Physical Properties

(1) Peel strength (gf/25 mm): Peel strength was measured 30 minutes after attaching the prepared polarizing plate to a glass substrate using a TA.XT_Plus Texture Analyzer (supplied by Stable Micro Systems Ltd., Godalming, United Kingdom).

(2) Durability: The prepared polarizing plate was attached to a glass substrate, left at 60° C./90% RH for 500 hours, and an occurrence of detachment, peeling or bubbling at an interface between the polarizing plate and the substrate was observed with the naked eye. Results were evaluated according to the following standards.

<Standard for Evaluation of Durability>

o: Good (No bubbling or peeling)

Δ: Good (Slight bubbling or peeling)

x: Poor (Substantial bubbling or peeling)

(3) Storage modulus (dyne/cm²): Adhesive layers (adhesives) were stacked to prepare a specimen having a diameter of 8 mm and a thickness of 1 mm, followed by measuring the storage modulus using an ARES (Advanced Rheometry Expansion System) at 25° C. and 80° C. in accordance with frequency sweep testing (frequency: 1 Hz basis).

(4) Degree of crosslinking (%): Degree of crosslinking was measured by dissolving the prepared adhesive in ethyl acetate for 3 days, measuring the weight of the undissolved portion, and then calculating the degree of crosslinking according to the formula below.

Degree of crosslinking (%)=(Weight of undissolved portion/weight of initial adhesive)*100

(5) Ability to inhibit light leakage (Evaluation of uniformity of light transmission): The polarizing plates prepared in Example 1 and Comparative Examples 1 to 3 to which the adhesive was attached were cut into samples having a size of 180 mm×250 mm (length×width). The samples were attached to a commercially available 19″ panel using a laminator. Then, the panel was pressed in an autoclave (at 50° C. and 5 atm.) for about 30 minutes, followed by maintaining the panel under conditions of 23° C. and 50% RH in a thermo-hygrostat for 24 hours to prepare specimens. Light transmission uniformity was measured for each specimen. Specifically, light was irradiated onto the specimen in a dark room, followed by observing light leakage with the naked eye. In evaluating light transmission uniformity, two polarizing plates, to which adhesives were attached, were attached perpendicular to each other (i.e., at a 90 degree angle to each other) to both sides of a liquid crystal cell, followed by irradiation from a backlight unit. Results were evaluated according to the following standards.

<Standard for Evaluation of Ability to Inhibit Light Leakage>

⊚: It is difficult to determine whether there is non-uniformity of light transmission with the naked eye.

o: There is insignificant non-uniformity of light transmission (e.g., the light transmission is uniform or substantially uniform).

Δ: There is some non-uniformity of light transmission.

x: There is substantial non-uniformity of light transmission (e.g., the light transmission is not uniform).

As shown in Table 1, in the polarizing plate prepared in Example 1, the adhesive exhibited good peel strength, durability and storage modulus, and it was difficult to determine whether there was non-uniformity of light transmission with the naked eye. On the contrary, in the polarizing plate prepared in Comparative Example 1, in which a polyfunctional acrylate and a radical photoinitiator were used instead of the epoxy resin and cationic photoinitiator, the adhesive exhibited a high storage modulus at 80° C. of 7×10⁵ dyne/cm², and insignificant non-uniformity of light transmission. In the polarizing plate prepared in Comparative Example 2, in which the epoxy resin and cationic photoinitiator were not used and UV irradiation was not performed, the adhesive exhibited low storage modulus at both 80° C. and 25° C., and some non-uniformity of light transmission, which indicated that the adhesive was not suitable for inhibiting light leakage. In addition, in the polarizing plate prepared in Comparative Example 3, in which 70 parts by weight of polyfunctional acrylate was used, the adhesive exhibited a high storage modulus at 80° C. of 1×10⁶ dyne/cm², and experienced detachment and substantial non-uniformity of light transmission, which indicated poor reliability.

Although some embodiments have been disclosed herein, it will be understood by those of ordinary skill in the art that these embodiments are provided by way of illustration only, and that various modifications, changes, alterations, and equivalent embodiments can be made by those of ordinary skill in the art without departing from the spirit and scope of the invention as defined by the following claims.

What is claimed is:

1. An acrylic adhesive composition, the acrylic adhesive composition comprising:
an acrylic resin;
an epoxy resin; and
a cationic photoinitiator,
wherein a cured product of the acrylic adhesive composition has a storage modulus of about 6×10⁶ dyne/cm² to about 1×10⁸ dyne/cm² at 25° C. and a storage modulus of about 5×10³ dyne/cm² to about 1×10⁵ dyne/cm² at 80° C.

2. The acrylic adhesive composition according to claim 1, wherein the acrylic resin is a copolymer of a monomer mixture comprising about 75 wt % to about 99.5 wt % of a C₄ to C₂₀ alkyl (meth)acrylate and about 0.5 wt % to about 25 wt % of a hydroxyl group-containing monomer, based on the total weight of the acrylic resin.

3. The acrylic adhesive composition according to claim 1, wherein the acrylic resin has a weight average molecular weight of about 700,000 g/mol or more.

4. The acrylic adhesive composition according to claim 1, wherein the acrylic resin has a glass transition temperature of −40° C. to −5° C.

5. The acrylic adhesive composition according to claim 1, wherein the epoxy resin is an epoxy compound having two or more epoxy functional groups.

6. The acrylic adhesive composition according to claim 1, wherein the epoxy resin comprises at least one selected from bisphenol A epoxy, bisphenol F epoxy, brominated bisphenol epoxy, 1,4-cyclohexanedimethanol diglycidyl ether, novolac epoxy, 1,6-hexanediol diglycidyl ether, and trimethylol propane triglycidyl ether.

7. The acrylic adhesive composition according to claim 1, wherein the cationic photoinitiator comprises at least one selected from iron-arene complexes and onium salts comprising at least one of aromatic diazonium salts, aromatic iodonium salts, or aromatic sulfonium salts.

8. The acrylic adhesive composition according to claim 1, wherein the epoxy resin is present in the acrylic adhesive composition in an amount of about 30 parts by weight to about 95 parts by weight and the cationic photoinitiator is present in the acrylic adhesive composition in an amount of about 0.5 parts by weight to about 3 parts by weight, based on 100 parts by weight of the acrylic resin.

9. The acrylic adhesive composition according to claim 1, further comprising a silane coupling agent.

10. An adhesive layer comprising the cured product of the acrylic adhesive composition of claim 1, wherein the cured product has a degree of cross-linking of about 50% to about 98% after curing with ultraviolet light.

11. A polarizing plate comprising:
a polarizing film; and
an adhesive layer on one or both sides of the polarizing film, the adhesive layer comprising the cured product of the acrylic adhesive composition of claim 1.

12. A liquid crystal display, the liquid crystal display comprising:
a liquid crystal panel; and
the polarizing plate of claim 11 on one or both sides of the liquid crystal panel.
